(19) United States
(12) Patent Application Publication
(10) Pub. No.: US 2017/0289172 A1
(43) Pub. Date: Oct. 5, 2017

(54) REQUEST AUTHENTICATION FROM MESSAGE CONTENT

(71) Applicant: Zeta (Better World Technology Pvt. Ltd.), Mumbai Maharastra (IN)

(72) Inventor: Bhavin Turakhia, Mumbai Maharastra (IN)

(21) Appl. No.: 15/157,211

(22) Filed: May 17, 2016

(30) Foreign Application Priority Data
Mar. 29, 2016 (IN) 201621010699

(51) Int. Cl. H04L 29/06; H04W 4/02; H04L 29/08

(52) U.S. Cl. CPC H04L 63/107; H04L 67/18; H04L 67/10; H04W 4/023; H04L 63/08; H04L 63/062

(57) ABSTRACT

In example embodiments, a system and method performs authentication and confirmation of requests within a control server system. Accordingly, a first message is received from a first device, the control server system responds to the request by providing a first code to the first device and the control server system maps the first code to a first identifier of the first user. The control server system receives a second request, including the first code, from a second device and identifies a second location associated with the second device. The control server system selects the first identifier based on inclusion of the first code in the second and the first location being within a predetermined proximity of the second location. The control server system processes the second request based on selection of the first identifier.

### CLAIM FOR PRIORITY

The application claims the benefit of priority to Indian Patent Application No. 201621010699, filed Mar. 29, 2016, entitled “REQUEST FROM MESSAGE CONTENT” which is incorporated herein by reference in its entirety.

### FIELD

The present disclosure relates generally to electronic communications, and in a specific example embodiment, to authentication of requests based on message content.

### BACKGROUND

Typically, when two entities engage in a transaction, such as transmitting messages between the two entities, a first entity transmits a message to a second entity. The second entity receives the transmitted message without further interaction by the first entity. The transmission of the message indicates completion of the communication. Affirmation of the communication by the first user is assumed based on the initiation of the communication by the first entity.

### BRIEF DESCRIPTION OF DRAWINGS

Various ones of the appended drawings merely illustrate example embodiments of the present disclosure and cannot be considered as limiting its scope.

FIG. 1 is a diagram illustrating a system for authentication of requests from message content, according to some example embodiments.

FIG. 2 is a block diagram illustrating a client device, according to some example embodiments.

FIG. 3 is a block diagram illustrating a control server system, according to some example embodiments.

FIG. 4 is a flow diagram of a method for request authentication from message content, according to some example embodiments.

FIG. 5 is a flow diagram of a method for request authentication from message content, according to some example embodiments.

FIG. 6 is a flow diagram of a method for request authentication from message content, according to some example embodiments.

FIG. 7 is a flow diagram of a method for request authentication from message content, according to some example embodiments.

FIG. 8 is a simplified block diagram of a machine in an example form of a computing system within which a set of instructions for causing the machine to perform any one or more of the methodologies discussed herein may be executed.

### DETAILED DESCRIPTION

In the following description, for purposes of explanation, numerous specific details are set forth in order to provide an understanding of various embodiments of the disclosure. It will be evident, however, to those skilled in the art, that embodiments of the disclosure may be practiced without these specific details.

Example embodiments described herein provide systems and methods for request authentication from message content to reconcile first requests, generated codes, and second requests. The first requests and the second requests are provided using two distinct devices. Authentication is performed to reconcile first requests, or codes provided based on the first requests, with second requests. A control server system receives a request triggered by an application operating on a user device. The control server system responds to the first request with a code provided for use in authenticating a subsequent request.

In one example embodiment, systems and methods herein describe an interaction between two users in which the control server system authenticates requests between two client devices to authorize and cause transfer of a value between the users when one user is offline. In these example embodiments, the first user instructs the control server to provide a code using a first request prior to interacting with a second user. The control server system provides the code to the first device. The code may be mapped to a location or a time such that outside of the mapped time or a distance from the location, the code is no longer valid. The control server system then receives a second request from a second device. The second request includes the code and a second location. In some instances, the first user may provide the first code to the second user of the second device. The first user may provide the code by stating the code to the second user or sending the code from the first device to the second device in a message or other transmission. The second request may include a value to be transferred from an account associated with the first user or first device to an account associated with the second user or second device. The second request may act as a portion of a transaction, such as an invoice statement or debit request, between the first user and the second user. Receipt of the second request causes the control server system to authenticate the second request based on inclusion of the first code and a comparison of the location associated with the first code and the second location of the second device. Upon authenticating the second request, the control server system transfers the value from the account of the first user to the account of the second user.

Accordingly, one or more of the methodologies discussed herein may enable the first user, in a value transfer between the first user and the second user, to interact indirectly or not at all with devices associated with the second user or the second domain or to be in communication with the control server at the time of the transaction. This may have the technical effect of reducing computing resources used by one or more devices of the first user and the second user. Examples of such computing resources include, without limitation, processor cycles, network traffic, memory usage, storage space, and power consumption. The methodologies described herein enable the first user and the second user to interact with one another and transfer values without specialized equipment or connectivity other than a mobile telephone and a network through which the mobile telephone may communicate and without the first user having any connectivity to the control server system at the time of the transaction. The systems and methods described herein may also have the technical effect of reducing the generation, tracking, and proliferation of security tokens (e.g., identification tokens) associated with the second domain, enabling more effective and secure use of security tokens. Additionally this has the benefit of the second user being able to leverage existing investments of devices in transfer of value using the control server system.

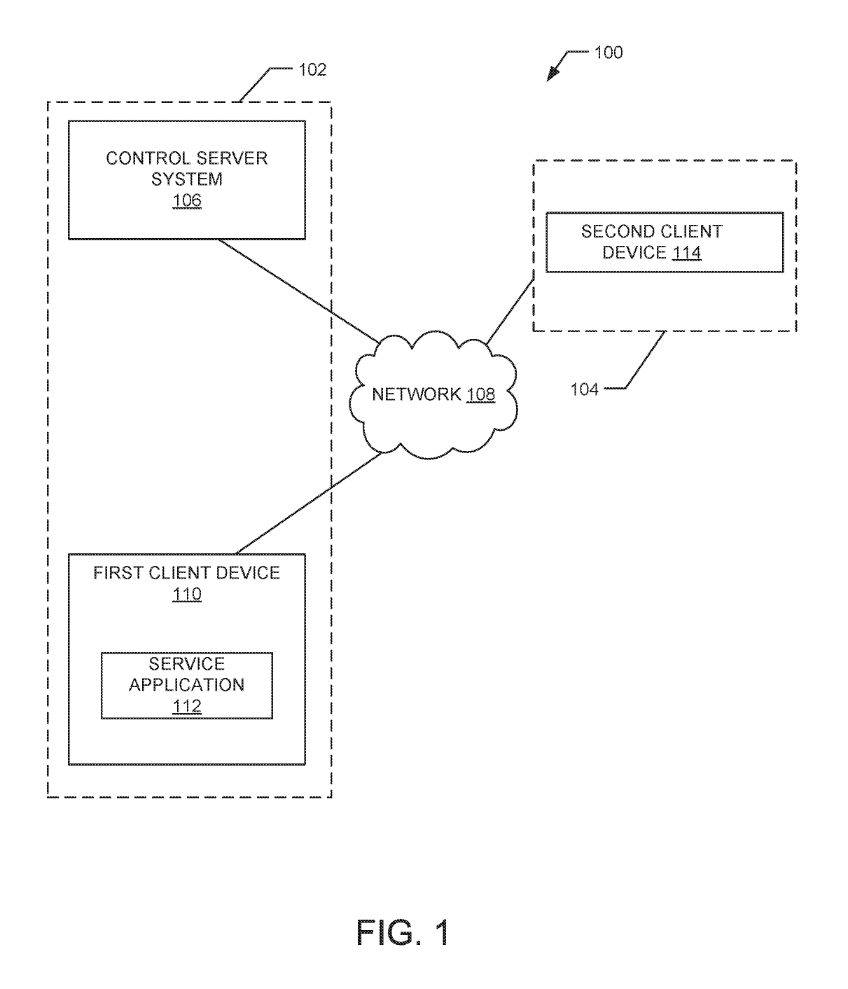

With reference to FIG. 1, a diagram illustrating an example environment 100 in which example embodiments of a system for request authentication and confirmation is shown. The environment 100 comprises a first domain 102 and a second domain 104. The first domain 102 contains a control server system 106 coupled via a network 108 (e.g., the Internet, wireless network, cellular network, or a Wide Area Network (WAN)) to a plurality of user devices. As shown in FIG. 1, the plurality of user devices are represented by a first client device 110, shown as a portion of the first domain 102 and including a service application 112. The second domain 104 contains a second client device 114. Although FIG. 1 shows the first domain 102 including the first client device 110 and the second domain 104 containing the second device 114, in some example embodiments, the first domain 102 may include the first client device 110 and the second client device 114.

Each client device 110 is associated with a user (e.g., a first user associated with the first client device 110 where the user is a member of or otherwise associated with the first domain 102) that has downloaded or otherwise installed a service application 112 onto their respective client device 110. The client device 110 may comprise a mobile phone, laptop, tablet, or any other communication device that a user may utilize to store, access, or operate the service application 112.

The service application 112 comprises application programming, functionality, or modules on the client device 110 that generates requests and messages enabling the control server system 106 to perform operations verifying, authenticating, reconciling, and processing requests from one or more client devices (e.g., the first client device 110 and the second client device 114). To that end, the control server system 106 may provide the service application 112 to one or more of the first client device 110 (e.g., provide a downloadable version of the service application 112, electronically send the service application 112 to the first client device 110, physically send to the first user via a storage medium such as a CD ROM) and the second client device 114.

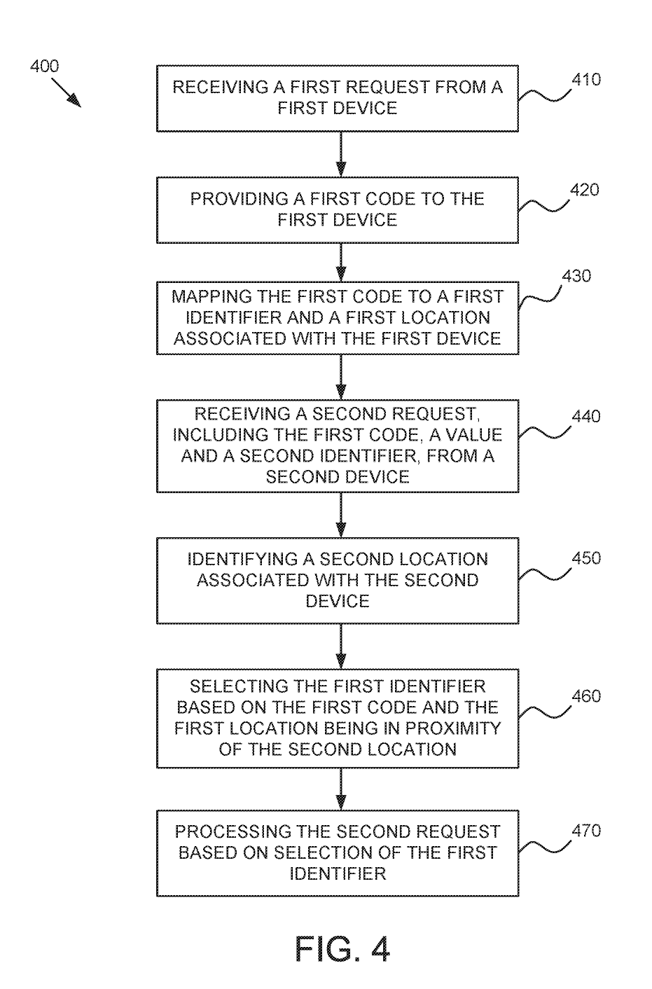

Once the service application 112 is installed on the first client device 110, the service application 112 may automatically verify a user identification corresponding to the first user associated with the first client device 110 (e.g., mobile number, e-mail address, phone number) and authenticate the first client device 110 and/or the user with the control server system 106. The authentication process may occur in the background of the first client device 110 without any user intervention. In example embodiments, the verification of the first user and the first client device 110 may comprise, in part, a registration process to register the first user with the control server and the first domain 102. The authentication process will be discussed in more detail in connection with FIG. 4 below.

The second client device 114 is a device associated with the second domain 104. The second client device 114 may be a client device including a service application similar to the first client device 110 and the service application 112, described above. Where the second client device 114 is associated with the second domain 104, the second client device 114 may be an electronic data capture terminal, a point of sale terminal, or any other suitable device and the second domain may be a payment network (e.g., a credit card network) such that the second client device 114 performs one or more payment operations through the second domain 104. The second client device 114 may be registered or otherwise associated with the control server system 106. In some example embodiments, the second client device 114 is a device capable of communication with the control server system 106 using a predefined message format. The second client device 114 may be a credit card reader, a point of sale system, a mobile phone, a tablet, a computer, a laptop, or any other suitable device configured to communicate the second domain 104 or the control server system 106 within the first domain 102. The second client device 114 may generate messages and requests for transmission to the control server system 106. In some example embodiments, the second client device 114 may receive confirmation messages from the control server system 106.

It is noted that the environment 100 shown in FIG. 1 is an example of such environments. Alternative example embodiments may comprise any number of control server systems 106 and client devices in communication in the environment 100.

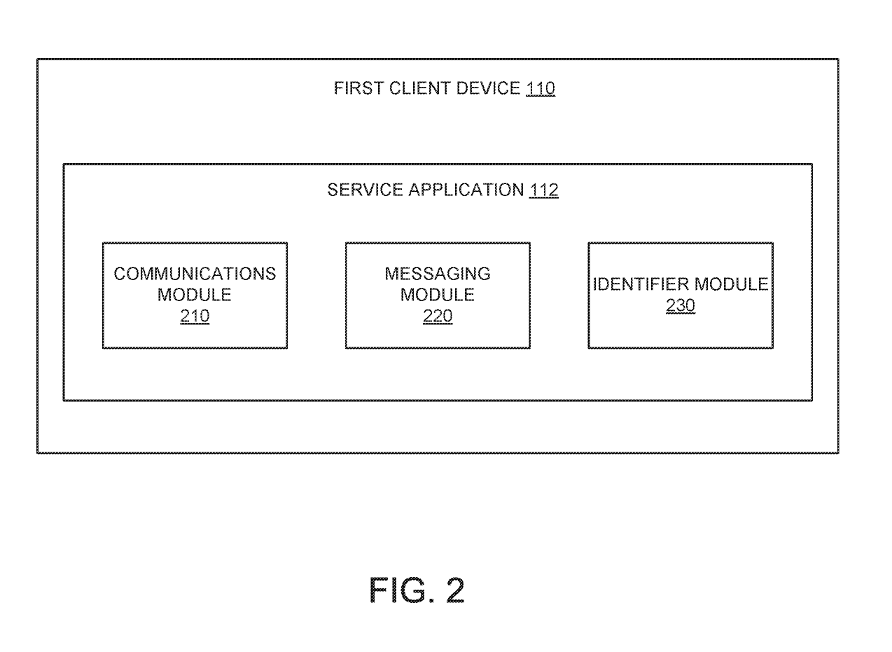

Referring now to FIG. 2, a block diagram illustrating an example embodiment of the first client device 110 is shown. The first client device 110 is shown having the service application 112 installed thereon. The service application 112 provides functionality and services to the first client device 110 that may be provided to and from the control server system 106. To enable the functionality on the first client device 110, the service application 112 may comprise a communications module 210, a messaging module 220, and an identifier module 230. It is noted that the service application 112 may comprise other modules not pertinent to example embodiments that are not shown or discussed.

The communications module 210 manages communications with the control server system 106. Upon installation, the communications module 210 may exchange communications with the control server system 106 to perform the verification and authentication (e.g., registration) of the first user and the first client device 110 with the control server system 106 and the first domain 102. In example embodiments, the communications module 210 may take over control of one or more communication capabilities of the first client device 110. In some instances, the communications module 210 takes control of one or more of the SMS messaging capabilities, the WiFi communication capabilities, and the cellular communication capabilities of the first client device 110 to exchange the communications with the control server system 106. The communications module 210 may determine a communication address for the control server system 106. The communication address may be a service number (e.g., phone number) or an address within the first domain 102. For example the address may be an Internet Protocol (IP) address, a domain name, or a uniform resource identifier (URI) for the control server system 106. The URI may be a uniform resource locator (URL) or a uniform resource name (URN). The communications module 210 uses the communication address to send a registration message to the control server system 106. In example embodiments, the communication address may be fetched by the communications module 210 from the control server system 106. Alternatively, the communication address may be hardcoded into the service application 112. The communications module 210 also receives reply messages from the control server system 106.

In various example embodiments, the messaging module 220 generates one or more registration messages and requests for transmission to the control server system 106 by the communications module 210. The one or more registration messages may establish an account of the first user with the control server system 106 and verify the identity of the first user. In example embodiments, the one or more registration messages include one or more of identification, demographic, and location information transmitted to the control server system 106 by the communications module 210. The messaging module 220 may also generate and transmit requests to the control server system 106 for codes generated by the control server system 106 to be used for authentication of messages and requests from other client devices and forming part of a transaction between the first client device 110 and the other client devices. The messaging module 220 may also generate and cause presentation of notifications on a display device associated with the first client device 110.

In various example embodiments, the identifier module 230 may apply an identifier associated with the first client device 110 or the first user to messages transmitted by the messaging module 220 to the control server system 106. In some example embodiments, the identifier module 230 verifies messages received from the control server system 106 contain the identifier for the first client device 110 or the first user. The identifier module 230 may identify a location of the first client device 110 to perform validation operations on the first code where the first client device 110 is not in communication with the control server system 106.

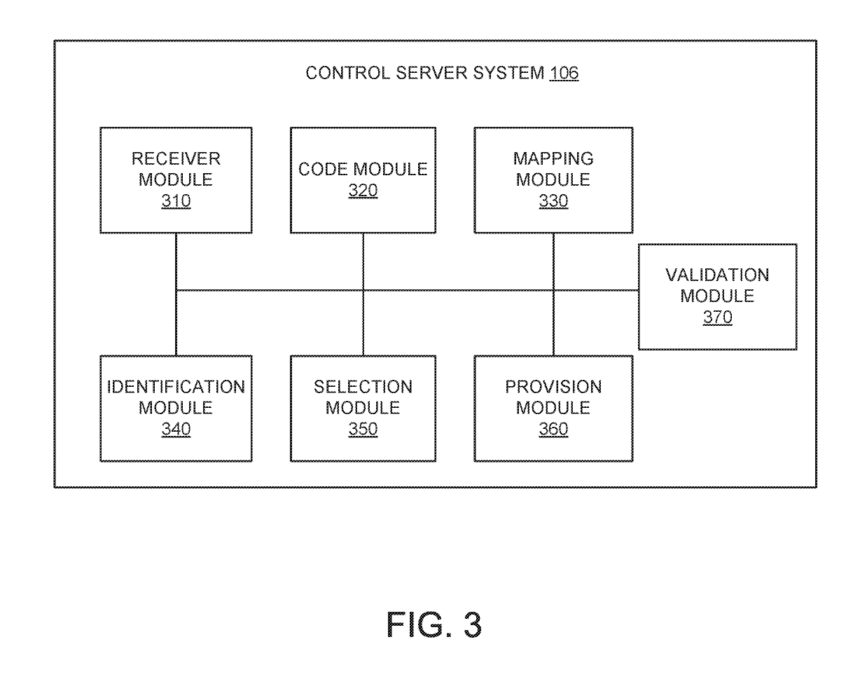

Referring now to FIG. 3, the control server system 106 is shown in more detail. In example embodiments, the control server system 106 comprises one or more servers that provide functionality and services to the service applications 112 running on the first client device 110. Prior to allowing the service application 112 to access content or functionalities with the control server system 106, the contact identifier (e.g., user identification) corresponding to the first client device 110 is verified as belonging to one or more of the first client device 110 and the first user. Validating the user identification authenticates the first client device 110 and the first user as associated with the first domain 102 and the control server system 106. In example embodiments, the control server system 106 uses the user identification (e.g., mobile number) corresponding to the first client device 110 or the first user as an authentication vector. Accordingly, the control server system 106 may comprise a receiver module 310, a code module 320, a mapping module 330, an identification module 340, a selection module 350, and a provision module 360. Alternative example embodiments may comprise more, less, or other modules for methods of request authentication and confirmation. Some functions of the modules may be combined or divided into two or more further modules.

The receiver module 310 is configured to receive requests from client devices (e.g., the first client device 110 or the second client device 114). The receiver module 310 may receive the requests via the network 108 (e.g., the Internet) or any other suitable network. The receiver module 310 may pass at least a portion of received requests to one or more additional modules of the control server system 106.

The code module 320 provides codes to the client devices in response to the receiver module 310 receiving a specified request. In some example embodiments, the code module 320 provides codes by selecting codes from a predetermined set of codes. The code module 320 may also generate codes upon receiving an indication of a request. The code module 320 may pass generated or selected codes to one or more module of the control server system 106.

The mapping module 330 maps codes to identifiers and locations associated with client devices from which requests for codes were received. The mapping module 330 may generate and modify data structures detailing associations between codes, identifiers, and locations. In some example embodiments, the mapping module 330 includes additional information in the map such as geographical location data, time data, expiration periods for time data, and other suitable identifying or tracking information. The mapping module 330 may monitor generated maps to identify and remove associations between codes and identifiers based on expiration of time data included in the association.

The identification module 340 selects identifiers based on inclusion in requests identified as responding to an initial request, identifier, and code. In some example embodiments, the identification module passes identifiers from the map to other modules within the control server system 106. The identification module 340 may also identify locations within requests. Based on identification of two or more locations within two or more requests, the identification module 340 may determine geographical proximities such as distances, radii, or coexistence within a region, city, street, or other geographical area.

The selection module 350 selects identifiers based on inclusion in second requests and proximity between first and second locations. The selection module 350 may determine distance in conjunction with the identification module 340.

The provision module 360 processes requests based on receipt of a confirmation responding to the request for confirmation. In some example embodiments, the provision module 360 may process requests by transferring values from an account associated with the identifier mapped to the code and a second account. The provision module 360 may communicate with domains (e.g., the second domain 104) outside the first domain 102 associated with the control server system 106 in order to process requests.

FIG. 4 is a flow diagram of an example method 400 for authentication of requests from a second device based on identifier and code mapping with respect to a first device, such as the first client device 110. The operations of the method 400 may be performed by the control server system 106 which may be embodied on one or more servers.

In operation 410, the receiver module 310 receives a first request from a first device. The first request may include a first identifier of a first user and a request for a code. In some example embodiments, the first request may be a message configured to fetch a code from the control server system 106. The first request may be generated within an application on the first device and configured to be transmitted to the control server system 106 to cause the control server system 106 to perform a set of operations, described in more detail below.

In some example embodiments, the first request includes a first value. The first value may represent a set of data, a message, a monetary value, or any other suitable value within the control server system 106, the first domain 102, or the second domain 104. For example, first request may initiate a transaction between a first user associated with the first device and a second user associated with a second device. The value may be a monetary value representing money being transferred between an account associated with the first user and an account associated with the second user. The value may be entered into a user interface causing generation of the first request within the first device.

In operation 420, the code module 320 provides a first code to the first device in response to the first request. The code module 320 provides the first code in response to the first request being received by the receiver module 310. The code may comprise a set of characters including numbers, letters, non-letter symbols, combinations thereof, or any other suitable characters. In some example embodiments, the first code is a nine character (e.g., digit) code. Although described as a specified number of digits, it should be understood that the code may include any number of suitable characters (e.g., three, four, five, six, seven, eight, ten digits). In some example embodiments, the first code may be generated upon receipt of the first request. Where the code is generated based on the receipt of the first message, the code may be generated based on a portion of the first message, identification information of the first device, identification information of the first user of the first device, based on a random number (e.g., character) algorithm, or any other suitable basis.

In example embodiments where the first request includes the value, the first code may be generated based on the value. In some example embodiments, the first code may be the value, a modification of the value, a code resulting from performing a mathematical operation on the value, a hash value based on the value, or any other code generated based on the value.

The first code may also be selected upon receipt of the first request. Where the first code is selected, the code module 320 may access a code database. The code database may include a set of preexisting or predetermined codes. The code module 320 may select the first code from the set of predetermined codes based on one or more criteria associated with the first message, the first device, the first user of the first device, a current state of network traffic, combinations thereof, or any other suitable basis.

In some instances, where the first code is selected from a set of predetermined codes in response to the first request, the code module 320 may determine a subset of codes included within the set of predetermined codes for provision to devices in response to a request. The subset of codes may include a predetermined number of unique codes of the set of predetermined codes. In some example embodiments, the predetermined number is determined based on the current state of network traffic (e.g., a number of devices requesting codes), a chance of collision (e.g., a probability that a code may be randomly selected and improperly submitted by a third party), and a number of codes of the subset which are currently associated with a client device (e.g., have been provided to a client device in response to a request and not yet released based on a subsequent request). In some example embodiments, the code module 320 determines one or more available codes from the subset of codes, as described in more detail below. The code module 320 may determine the one or more available codes as one or more codes of the subset of codes which are not currently mapped or otherwise associated with a client device in response to a request. The code module 320 may then select the first code from the one or more available codes.

The code module 320 may modify the predetermined set of codes based on one or more provision factors. The one or more provision factors may include a rate at which the control server system 106 is receiving requests for codes, a number of codes which are currently assigned to client devices within a given time period, a current state of network traffic (e.g., frequency of provisioning codes, frequency of requests, and a proximity of client devices requesting codes), or any other suitable factor affecting the probability of providing unique codes to each client device requesting a code. Based on the provision factors, the code module 320 may modify the predetermined set of codes by increasing a number of codes within the predetermined set, adding one or more differentiation indicator to each code of the predetermined set of codes, modifying the one or more differentiation indicators for the predetermined set of codes, or modifying a type of characters used within the predetermined set of codes. For example, to change the number of codes within a range of the predetermined set of codes, the code module 320 may increase a number of characters used within the predetermined set of codes from six characters to seven characters. Differentiation indicators used to enable uniquely provisioning a single code to multiple client devices may include a color (e.g., red, blue, green, and yellow), a location, a range (e.g., a radius extending out from a selected location), or any other suitable differentiating values which may be associated with each code of the predetermined set of codes. The code module 320 may add differentiation indicators in stages, initially using binary differentiation (e.g., two colors for each code) and periodically increase the differentiation indicators based on the one or more provision factors. The code module 320 may modify the predetermined set of codes by changing the predetermined set of codes from characters of a first type (e.g., numbers) characters of a second type (e.g., alphanumeric characters).

In some example embodiments, the first code is associated with a predetermined period of time. in providing the first code to the first device, the code module 320 may initialize the predetermined time period based on providing the first code to the first device. In some instances, the code module 320 initializes the predetermined time period by starting the predetermined time period or otherwise identifying a time at which the first code was provided to the first device. Once the predetermined period of time is initialized for the association of the first code and the first device, the code module 320 may identify a time at which the predetermined period of time lapses, Upon expiration or lapsing of the predetermined period of time, the code module 320 dissociates, ends, or otherwise terminates the association of the first code to the first device. In some example embodiments, upon expiration or lapsing of the predetermined time period, the code module 320 may operation in cooperation with one or more other modules to determine or otherwise validate the first code on the first client device, as described in more detail below.

In operation 430, the mapping module 330 maps the first code to the first identifier and a first location associated with the first device. The mapping module 330 may generate a map associating the first code, the first identifier, and the first location. The first location is associated with the first device and represents the location or geographical region of the first device. The first location may have been obtained separately or along with the first request. The map generated by the mapping module 330 may be a data structure (e.g., a table or an array) detailing the association of the first code and the first identifier. The map may include associations of a plurality of client devices, a plurality of codes, and a plurality of locations.

In some example embodiments, where the codes are associated with predetermined time periods, the mapping module 330 may generate a temporary map or temporary associations within the map. Where the map contains temporary associations, the mapping module 330 may constantly monitor codes having an association within the map. The mapping module 330 may assign associations between the codes and the identifiers within the map. The mapping module 330 may then associate the predetermined time period of each respective code to its position within the map. The mapping module 330 may identify a time at which the predetermined time period expires. Once the predetermined time period for a code expires, the mapping module 330 may remove the code, the associated identifier, and the associated location from the map. In some instances, once the predetermined time period expires, the mapping module 330 in cooperation with one or more other modules may validate the first code on the first identifier.

In some example embodiments, the mapping module 330 may determine a current location of the first device. The mapping module 330 may determine the current location based on a global positioning system (GPS) location identified by one or more components of the first device (e.g., a GPS chip or module). The current location may be periodically or continually updated within the first device. The mapping module 330 may determine the current location by transmitting a location request to the first device. The location request may be configured to request location current location data in the form of a current GPS location for the first device.

In some example embodiments, the mapping module 330 determines the current location of the first device on a periodic basis. The mapping module 330 may be triggered to determine the current location of the first device in response to the expiration of the predetermined time period associated with the first code. In these instances, upon expiration of the predetermined time period, the mapping module 330 initiates transmission of the location request. The mapping module 330 may also be triggered to determine the current location based on a location time period. For example, the location time period may be a period of time amounting to less than that of the predetermined time period associated with the first code. In these example embodiments, the mapping module 330 may initiate transmission of the location request based on a time period distinct from the time period associated with the first code to monitor the current location of the first device during the pendency of the time period associated with the first code. In other embodiments the first device may be configured to send the current location to the mapping module 330 at predetermined times or events.

After the mapping module 330 receives the current location of the first device, in response to the location request, the mapping module 330 may determine a proximity of the current location to the first location received within the first request. In some example embodiments, the proximity may be a predetermined geographic range, a distance, a radius, or any other suitable proximity. The mapping module 330 may determine the proximity of the current location to the first location by an arc, a straight line, or any other distance calculation between at least a portion of the current location and the first location. For example, the mapping module 330 may determine the proximity as a distance between two points, an intersection of radii, a proximity of two geographic divisions (e.g., a neighborhood, a city, or a pair of streets).

In response to the location of the first device exceeding a predetermined geographic range from the second location, the mapping module 330 may pass a code generation command to the code module 320. The code module 320 may provide a subsequent code to the first device. The code module 320 may provide the subsequent code to the first device in a manner similar to or the same as the operation 420, described above.

Upon the location of the first device exceeding the predetermined geographic range and the code module 320 providing a subsequent code to the first device, the mapping module 330 may expire the first code by causing deletion of the first code from the map and the application on the first device. In some instances, the mapping module 330 expires the first code by removing the first code from the map. At the first device, the code module 320 or the mapping module 330 may cause an application on the first device to update such that the first code is removed or deleted and the subsequent code replaces the first code.

In operation 440, the receiver module 310 receives a second request from a second device (e.g., the second device 114). The second request including the first code, a value, and a second identifier, The value may represent a monetary value being transferred as part of a transaction represented by the first request and the second request. For example, the first user of the first device may be a purchaser of goods or services and transmit the request to the control server system 106 to begin a transaction between the first user and the second user (e.g., a merchant) of the second device. Once the first code is received by the first device, the first user may provide (e.g., show or send) the code to the second user. The second user may enter the first code and the value into an application to generate the second message and transmit the second message to be received by the receiver module 310.

In some example embodiments, where the first code is associated with a predetermined period of time, the second request may be received within the predetermined period of time from the providing of the first code. In these instances, to process the second request, the receiver module 310 or the identification module 340 may initially identify the predetermined time period associated with the first code. The modules may then determine a remaining time for the predetermined time period and determine whether the second request was received during the pendency of the predetermined time period. Where the second request is received within the predetermined time period, the modules may continue with the method 400. Where the second request is received after expiration of the predetermined time period, the provision module 360 may generate an error or failure notification and transmit the notification to the second device.

In operation 450, the identification module 340 identifies a second location associated with the second device. The identification module 340 may identify the second location based on GPS coordinates of the second device or the second user. In these instances, the identification module 340 may identify the second location as included in the second request or may transmit a location request to the second device to identify the second location. In some instances, the second device may be associated with a static location (e.g., a storefront, a postal address, or a geographic location). In these example embodiments, the second location may be determined by parsing a data structure containing a mapping of second device identifications, included in the second response, and the second location of the second device. In other embodiments the second device maybe configured to send its location at predetermined periods or events.

In operation 460, the selection module 350 selects the first identifier based on inclusion of the first code in the second request and based on a comparison of the first location with the second location. For example, the comparison of the first location with the second location may be determined by the first location being within a predetermined proximity of the second location. The receiver module 310 may pass all or a portion of the second request to the selection module 350. For example, the receiver module 310 may pass the first code to the selection module 350 and an indication that the first code was received within the second request. The identification module 340 may identify and select the first identifier based on the map generated by the mapping module 330 and the proximity of the first location and the second location.

The selection module 350 or the mapping module 330 may determine the proximity of the first location and the second location as described above with respect to some example embodiments of the operation 430. For example, the selection module 350 or the mapping module 330 may identify the predetermined proximity (e.g., within a unit of distance, within a single city block, or within a city). The selection module 350 or mapping module 330 may determine a distance between the first location and the second location. The selection module 350 or the mapping module 330 may then compare the distance between the locations with the predetermined proximity.

In some example embodiments, in the operation 460, where the first code contains a first value, the second request includes a checksum. The checksum may be generated based on the first value. In some instances, the checksum is generated based on the value included in the second request and the first code. In these example embodiments, the second request and the first code may be validated by the validation module 370. The validation module 370 may validate the second request and the first code by confirming the checksum in response to receiving the second request. In some instances, the validation module 370 validates the second request and the first code by calculating a validation checksum from the first code and the first value included in the first request. In response to calculating the validation checksum, the validation module 370 compares the checksum from the second request with the validation checksum. Where the checksum from the second request and the validation checksum match, the validation module 370 validates the second request and the first code and performs the operation 470. Where the checksum from the second request and the validation checksum do not match, one or more of the validation module 370 and the provision module 360 may deny the processing (e.g., fulfillment) of the second request.

In operation 470, the provision module 360 processes the second request based on selection of the first identifier. In some example embodiments, processing the second request includes performing one or more actions within the control server system 106. The control server system 106 may modify one or more values within a database associated with the control server system 106 to process the second request. In some instances, the control server system 106 processes the second request by modifying or transferring a value within the control server system 106 to another domain (e.g., the second domain 104) or another system and modify the map described above to remove the association of the first code and the first identifier.

In some example embodiments, processing the second request includes transferring a value from the first user to a second user associated with the second device. In some instances, the value transferred between the first user and the second user is equal to one or more of the first value (e.g., a value included in the first request) and the value (e.g., a value included in the second request). In some example embodiments, one or more of a first account (e.g., the account of the first user or first device) and a second account (e.g., the account of the second user or second device) may be associated with a domain other than a domain for the control server system 106. The provision module 360 may generate a provision request to the domain associated with the first account or the second account. The provision request may cause the associated domain to transfer the value to or from the account associated with the domain. For example, where the first account is associated with the first domain 102 of the control server system 106, the provision module 360 may generate the provision request to transfer the value from the first account within the first domain 102 to the second account associated with the second domain 104.

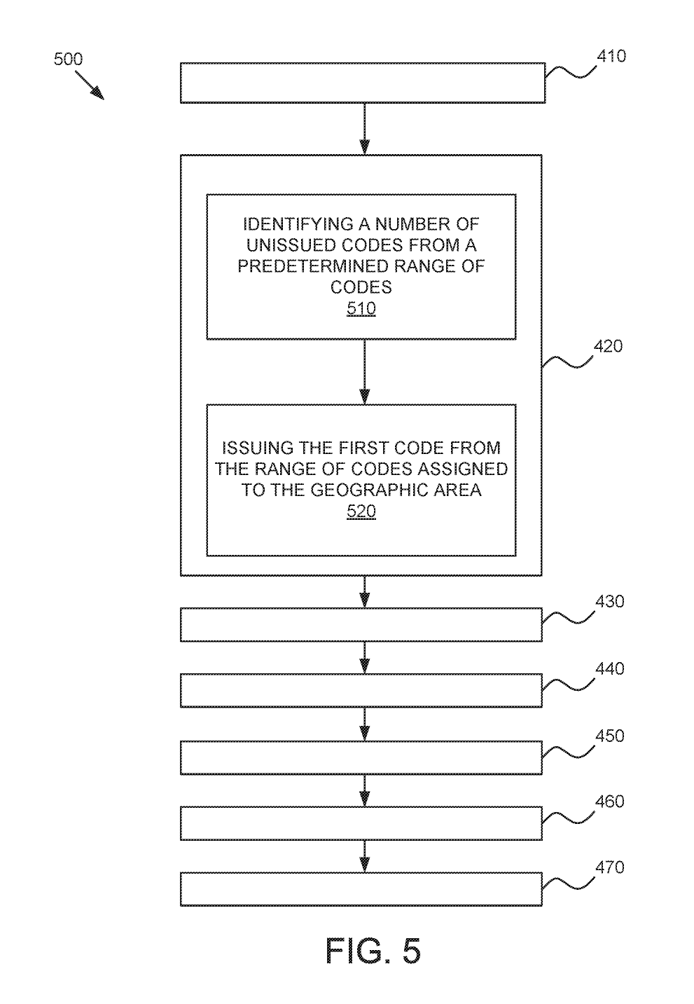

FIG. 5 is a flow diagram of an example method 500 authentication of requests from a second device based on identifier and code mapping with respect to a first device. In example embodiments, operations of the method 500 are performed as one or more sub-operations of one or more operations of the method 400. In example embodiments, the method 500 is initiated by the control server system 106 performing the operations 410 and the operations of the method 500 are sub-operations or portions of the operation 420.

In operation 510, one or more of the code module 320 and the mapping module 330 identifies a number of issued codes from a predetermined range of codes assigned to a geographic region. In response to a request for a code, the code module 320 or the mapping module 330 may parse the map of codes for codes within the predetermined range of codes. The modules may identify the number of issued codes as codes included in the map as associated with an identifier and a location. In some example embodiments, the number of issued codes are a portion of the codes of the predetermined range of codes which have been issued to devices and are currently unavailable for issue within the assigned geographic region.

In operation 510, the code module 320 and the mapping module 330 determine the number of issued codes is within a predetermined number of codes assigned to the geographic region. In some example embodiments, the predetermined number of codes is a number of the codes within the predetermined range of codes which may be associated with an identifier and a location at a given time. The codes from the predetermined code range may be randomly selected for association with identifiers and locations while the absolute number of codes which have been associated remain below the predetermined number (e.g., a threshold of issued codes). For example, where the predetermined range of codes is between zero and one hundred million, the predetermined number of codes which may be issued at any given time may be 100,000 codes. In operation 510, the code module 320 or the mapping module 330 may first determine the number of issued codes and determines whether the number of issued codes exceeds 100,000 codes. Where the number of issued codes is below 100,000 codes, a request for a code may receive a code, incrementing the number of issued codes. Where the number of issued codes is equal to 100,000 codes, the request for code may be denied or another operation may be performed.

In operation 520, the code module 320 issues the first code as a unique code from the range of codes assigned to the geographic area based on determining the number of issued codes is within the predetermined number of codes. The first code may be selected from the number of unissued codes. In some example embodiments, the first code may be selected randomly or pseudo-randomly. In some instances, the first code may be selected based on a selection criterion. For example, the first code may be selected sequentially as the first available (e.g., lowest value or first within a list) of the number of unissued codes.

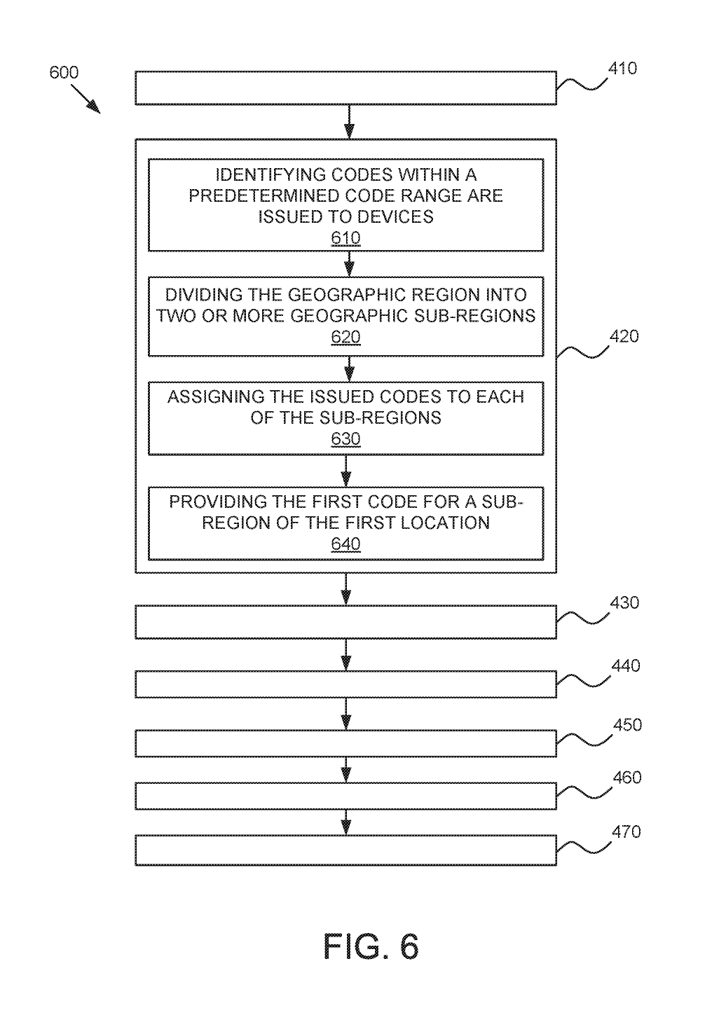

FIG. 6 is a flow diagram of an example method 600 authentication of requests from a second device based on identifier and code mapping with respect to a first device. In example embodiments, operations of the method 600 are performed as one or more sub-operations of one or more operations of the method 400. In example embodiments, the method 600 is initiated by the control server system 106 performing the operations 410 and the operations of the method 600 are sub-operations or portions of the method 420.

In operation 610, one or more of the code module 320 and the mapping module 330 identifies that a predetermined number of codes from a predetermined code range are issued to one or more devices. The predetermined code range may be currently assigned to a geographic region. The geographic region may be a single region capable of division with respect to the determination off locations for devices. For example, the geographic region may be a region which may be accurately subdivided into smaller regions while maintaining accuracy of determining locations of devices within the subdivided smaller regions. In some instances, the determination that the codes are issued to one or more devices indicates each code of the predetermined code range is assigned or mapped to an identifier in response to a request from a client device.

In operation 620, the code module 320 divides the geographic region into two or more geographic sub-regions. The code module 320 may perform the operation based on the predetermined number of codes of the predetermined code range being issued. In some example embodiments, the geographic region may be divided into two sub-regions based on an equal division or approximately equal division of the geographic region. In some instances, division into sub-regions may be based on use characteristics of portions of the geographic region. In these instances, the code module 320 may determine one or more of a frequency of use, a population density, a number of users or devices (e.g., second devices) associated with the geographic region, or any other suitable use characteristic. The code module 320 may divide the geographic region into sub-regions, equalizing the use characteristics between the two sub-regions.

In operation 630, the code module 320 assigns the issued codes of the geographic region to each of the two or more geographic sub-regions. Each code of the predetermined code range may be duplicated such that each geographic sub-region includes a separate, but identical predetermined code range. The codes which were mapped within the geographic region as being assigned to a device may be identified and mapped to the same device in the sub-region. For example, where a code is mapped to a specified device and the geographic region is split, the code module 320 may identify the mapped code as having an associated location within a first sub-region. The mapping module 330 may identify the mapped code within the first sub-region as being mapped to the specified device. The identical code within a second sub-region may be unmapped and available for issuance to a device.

in operation 640, the code module 320 provides the first code from the range of codes for a geographic sub-region of the two or more geographic sub-regions corresponding to the first location. In some example embodiments, the code module 320 and the mapping module 330 identify an available code for the geographic sub-region in which the first location is located and assigns the code as the first code. In these instances, an identical code for the other sub-region may already be assigned.

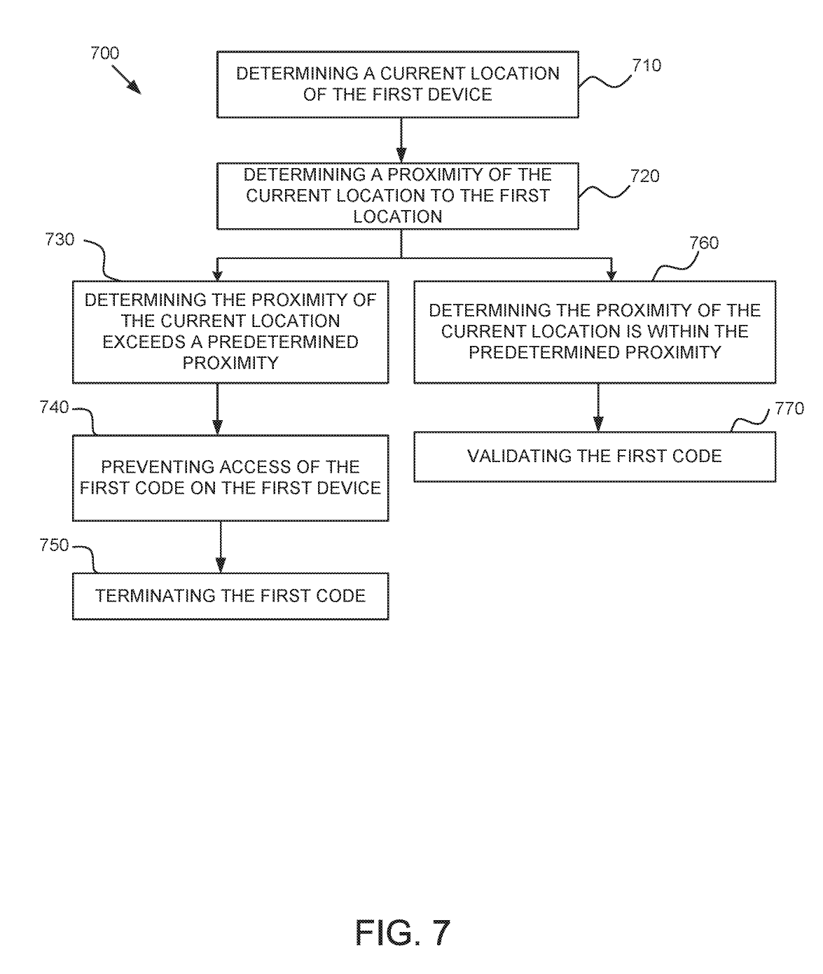

FIG. 7 is a flow diagram of an example method 700 for validating a provided code prior to authentication of requests from a second device based on identifier and code mapping with respect to a first device. In example embodiments, operations of the method 700 are performed as one or more sub-operations of one or more operations of the method 400. In example embodiments, the method 700 is initiated by the control server system 106 performing the operations 410-440.

In some example embodiments, the first code is received in the second request is an externally validated code. The method 700 may provide processes by which the first code is validated. The external validation may be performed by the device (e.g., the first device) which transmitted or initiated transmission of the first request to the control server system 106.

In operation 710, the identifier module 230 determines a current location of the first device. The identifier module 230 may identify the current location of the first device based on the GPS coordinates of the first device. Although described as determining location based on GPS coordinates, it should be understood that the identifier module 230 may identify the current location of the first device in any suitable manner. In some instances, the identifier module 230 identifies the current location of the first device in a manner which does not utilize a network which enables connection between the first device and the control server system 106.

in operation 720, the identifier module 230 determines a proximity of the current location to the first location. The identifier module 230 of the first device may determine the proximity based on a distance between the current location and the first location, an intersection of radii, or any other suitable distance measuring technique, as described above.

in operation 730, the identifier module 230 determines the proximity of the current location to the first location exceeds a predetermined proximity. In these example embodiments, the identifier module 230 determines the current location is outside of a suitable range from the first location. For example, the identifier module 230 may compare a distance between the current location and the first location to the predetermined proximity or range and determine the distance is greater than the predetermined proximity.

In operation 740, the messaging module 220 prevents access of the first code on the first device in response to determining the predetermined proximity is exceeded. In some instances, the messaging module 220 may remove, obfuscate, obscure, gray out, or otherwise prevent access of the first code by preventing rendering of the first code on a display device of the first device. The messaging module 220 may modify a graphical user interface or generate a new user interface to effect the removal of the first code from view on the display device.

Within the service application 112, the messaging module 220 may generate a notification that the first code is currently invalid. The notification may indicate a new request is to be transmitted prior to presenting a code. In some instances, where the first device is unable to connect to the control server system 106, the notification may indicate a network failure and direct the user to try again at a later time, check network settings, or move to a location suitable for a network connection to the control server system 106.

In operation 750, one or more of the identifier module 230 and the messaging module 220 terminates the first code. The first code may be terminated by removing the first code from the graphical user interface. In some instances, termination of the first code may be performed by removing or deleting the first code from a non-transitory processor readable storage medium associated with the first device.

In operation 760, the identifier module 230 determines the proximity of the current location to the first location is within the predetermined proximity. In these example embodiments, the identifier module 230 may determine that a distance between the current location and the first location is less than or equal to the predetermined proximity. The identifier module 230 may perform the operation using any distance comparison technique, operation, or set of operations.

In operation 770, the messaging module 220 validates the first code. Validation of the first code may enable access of the first code. For example, upon initiating the application, after previously receiving the first code, the identifier module 230 and the messaging module 220 may determine the current location is within the predetermined proximity and cause presentation of the previously received first code. In these instances, the messaging module 220 validates the code for presentation to a second user of the second device such that the code may be transmitted to the control server system 106 in the second request.

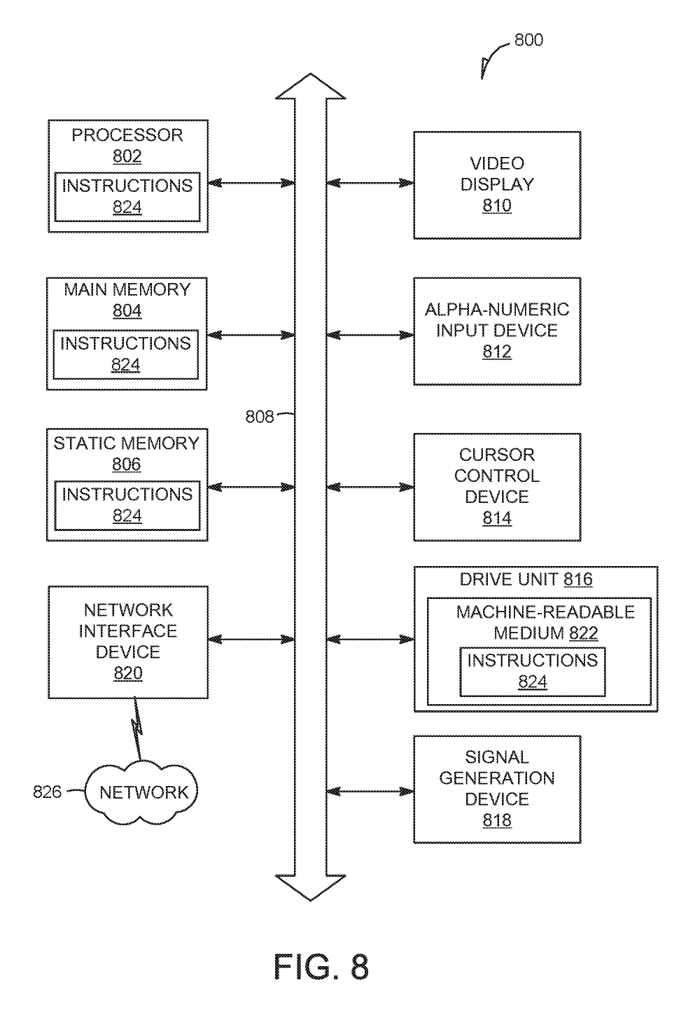

FIG. 8 is a block diagram illustrating components of a machine 800, according to example embodiments, able to read instructions (e.g., processor executable instructions) from a machine-readable medium (e.g., a non-transitory processor-readable storage medium) and perform any one or more of the methodologies discussed herein. Specifically, FIG. 8 shows a diagrammatic representation of the machine 800 in the example form of a computer system and within which instructions 824 (e.g., software, a program, an application, an applet, an app, or other executable code) for causing the machine 800 to perform any one or more of the methodologies discussed herein may be executed. In alternative example embodiments, the machine 800 operates as a standalone device or may be connected (e.g., networked) to other machines. in a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics/video display 810 (e.g., a plasma display panel (PDP), a light emitting diode (LED) display, a liquid crystal display (LCD), a projector, or a cathode ray tube (CRT)). The machine 800 may also include an alpha-numeric input device 812 (e.g., a keyboard), a cursor control device 814 (e.g., a mouse, a touchpad, a trackball, a joystick, a motion sensor, or other pointing instrument), a storage/drive unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the tangible machine-readable medium 822 is shown in an example embodiment to be a single medium, the terms “machine-readable medium” and “processor-readable medium” should be taken to include a single medium or multiple media (e.g., a centralized or distributed database, or associated caches and servers) able to store instructions. The terms “machine-readable medium” and “processor-readable medium” shall also be taken to include any medium, or combination of multiple media, that is capable of storing instructions for execution by a machine (e.g., machine 800). such that the instructions (e.g., instructions 824), when executed by one or more processors of the machine (e.g., processor 802), cause the machine to perform any one or more of the methodologies described herein. Accordingly, a “machine-readable medium” or “processor-readable medium” refers to a single storage apparatus or device, as well as “cloud-based” storage systems or storage networks that include multiple storage apparatus or devices. The terms “machine-readable medium” and “processor-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain example embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering example embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In example embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the disclosure has been described with reference to specific example embodiments, various modifications and changes may be made to these example embodiments without departing from the broader scope of example embodiments of the present invention. Such example embodiments of the disclosure may be referred to herein, individually or collectively, by the term “invention” merely for convenience and without intending to voluntarily limit the scope of this disclosure to any single application if more than one is, in fact, disclosed.

The example embodiments illustrated herein are described in sufficient detail to enable those skilled in the art to practice the teachings disclosed. Other example embodiments may be used and derived therefrom, such that structural and logical substitutions and changes may be made without departing from the scope of this disclosure. The Detailed Description, therefore, is not to be taken in a limiting sense, and the scope of various example embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various example embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of example embodiments of the present invention as represented by the appended claims. The specification and drawings are, accordingly, to be regarded in an illustrative rather than a restrictive sense.

What is claimed is:

1. A method comprising:
receiving, at a control server, a first request from a first device, the first request including a first identifier of a first user and a request for a code;
in response to the first request, providing a first code to the first device;
mapping, by the control server, the first code to the first identifier and a first location associated with the first device;
receiving, at the control server, a second request from a second device, the second request including the first code, a value, and a second identifier;
identifying a second location associated with the second device;
selecting, at the control server, the first identifier, the selecting of the first identifier being based on inclusion of the first code in the second request and based on a comparison of the first location with the second location determining that the first location and the second location are within a predetermined proximity; and
processing the second request based on selection of the first identifier.

2. The method of claim 1, further comprising:
identifying a number of issued codes from a predetermined range of codes assigned to a geographic region;
determining the number of issued codes is within a predetermined number of codes assigned to the geographic region; and
based on determining the number of issued codes is within the predetermined number of codes, issuing the first code as a unique code from the predetermined range of codes assigned to the geographic region.

3. The method of claim 1, wherein further comprising:
identifying a predetermined number of codes from a predetermined code range are issued to one or more devices, the predetermined code range assigned to a geographic region;
based on the predetermined number of codes being issued, dividing the geographic region into two or more geographic sub-regions;
assigning the issued codes of the geographic region to each of the two or more geographic sub-regions; and
providing the first code from the predetermined range of codes for a geographic sub-region corresponding to the first location.

4. The method of claim 1, wherein the first code is associated with a predetermined period of time and selection of the first identifier is based on the second request being received within the predetermined period of time from the providing of the first code.

5. The method of claim 1, wherein the first request includes the value and the second request includes a checksum generated based on the value and wherein selecting the first identifier further comprises:
validating, by the control server, the first code by confirming the checksum in response to receiving the second request.

6. The method of claim 1 further comprising:
determining a current location of the first device;
determining the proximity of the current location to the first location exceeds a predetermined proximity;
in response to determining the predetermined proximity is exceeded, preventing access of the first code on the first device; and
terminating the first code.

7. The method of claim 1, wherein processing the second request further comprises transferring a value from the first user to a second user, the second device being associated with the second user.

8. A system, comprising:
one or more processors; and
a non-transitory processor-readable storage medium storing processor executable instructions that, when executed by the one or more processors, cause the one or more processors to perform operations including:
receiving, at a control server, a first request from a first device, the first request including a first identifier of a first user and a request for a code;
in response to the first request, providing a first code to the first device;
mapping, by the control server, the first code to the first identifier and a first location associated with the first device;
receiving, at the control server, a second request from a second device, the second request including the first code, a value, and a second identifier;
identifying a second location associated with the second device;
selecting, at the control server, the first identifier, the selecting of the first identifier being based on inclusion of the first code in the second request and based on a comparison of the first location with the second location; and
processing the second request based on selection of the first identifier.

9. The system of claim 8, further comprising:
identifying a number of issued codes from a predetermined range of codes assigned to a geographic region;
determining the number of issued codes is within a predetermined number of codes assigned to the geographic region; and
based on determining the number of issued codes is within the predetermined number of codes, issuing the first code as a unique code from the range of codes assigned to the geographic region.

10. The system of claim 9, wherein further comprising:
identifying a predetermined number of codes from a predetermined code range are issued to one or more devices, the predetermined code range being assigned to a geographic region;
based on the predetermined number of codes being issued, dividing the geographic region into two or more geographic sub-regions;
assigning the issued codes of the geographic region to each of the two or more geographic sub-regions; and
providing the first code from the range of codes for a geographic sub-region corresponding to the first location.

11. The system of claim 8, wherein the first request includes the value and the second request includes a checksum generated based on the value and wherein selecting the first identifier further comprises:
validating, by the control server, the first code by confirming the checksum in response to receiving the second request.

12. The system of claim 8, wherein processing the second request further comprises transferring a value from the first user to a second user, the second device being associated with the second user.

13. The system of claim 8, wherein the operations further comprise:
determining a current location of the first device;
determining the proximity of the current location to the first location exceeds a predetermined proximity;
in response to determining the predetermined proximity is exceeded, preventing access of the first code on the first device; and
terminating the first code

14. A non-transitory processor-readable storage medium storing processor executable instructions that, when executed by a processor, cause the processor to perform operations comprising:
receiving, at a control server, a first request from a first device, the first request including a first identifier of a first user and a request for a code;
in response to the first request, providing a first code to the first device;
mapping, by the control server, the first code to the first identifier and a first location associated with the first device;
receiving, at the control server, a second request from a second device, the second request including the first code, a value, and a second identifier;
identifying a second location associated with the second device;
selecting, at the control server, the first identifier, the selecting of the first identifier being based on inclusion of the first code in the second request and based on a comparison of the first location with the second location; and
processing the second request based on selection of the first identifier.

15. The non-transitory processor-readable storage medium of claim 14, wherein the operations further comprise:
identifying a number of issued codes from a predetermined range of codes assigned to a geographic region;
determining the number of issued codes is within a predetermined number of codes assigned to the geographic region; and
based on determining the number of issued codes is within the predetermined number of codes, issuing the first code as a unique code from the range of codes assigned to the geographic region.

16. The non-transitory processor-readable storage medium of claim 14, wherein the operations further comprise:
identifying a predetermined number of codes from a predetermined code range are issued to one or more devices, the predetermined code range being assigned to a geographic region;
based on the predetermined number of codes being issued, dividing the geographic region into two or more geographic sub-regions;
assigning the issued codes of the geographic region to each of the two or more geographic sub-regions; and
providing the first code from the predetermined range of codes for a geographic sub-region corresponding to the first location.

17. The non-transitory processor-readable storage medium of claim 14, wherein the first request includes the value and the second request includes a checksum generated based on the value and wherein selecting the first identifier further comprises:
validating, by the control server, the first code by confirming the checksum in response to receiving the second request.

18. The non-transitory processor-readable storage medium of claim 14, wherein processing the second request further comprises transferring a value from the first user to a second user, the second device being associated with the second user.

19. The non-transitory processor-readable storage medium of claim 14, wherein the operations further comprise:
determining a current location of the first device;
determining the proximity of the current location to the first location exceeds a predetermined proximity;
in response to determining the predetermined proximity is exceeded, preventing access of the first code on the first device; and
terminating the first code
